(19) United States
(12) Patent Application Publication
(10) Pub. No.: US 2007/0075217 A1
(43) Pub. Date: Apr. 5, 2007

(54) Backlight module

(75) Inventors: Tzu-Shou Kuo, Chu Nan (TW); Pei-Ting Chen, Chu Nan (TW)

Correspondence Address: DAVIDSON BERQUIST JACKSON & GOWDEY LLP, 4300 WILSON BLVD., 7TH FLOOR, ARLINGTON, VA, 22203, US

(73) Assignee: CORETRONIC CORPORATION, Chu Nan (TW)

(21) Appl. No.: 11/521,442

(22) Filed: Sep. 15, 2006

(30) Foreign Application Priority Data
Oct. 5, 2005 (TW) 094134788

(51) Int. Cl. G01J 1/32

(52) U.S. Cl. 250/205; 250/239

(57) ABSTRACT

A backlight module includes a base, a light source unit, a light guide unit, a light sensor unit, and a controller. The base confines a receiving space. The light source unit is disposed in the receiving space. The light guide unit extends into the receiving space for guiding a portion of light emitted by the light source unit outwardly from the receiving space. The light sensor unit is disposed outside the receiving space to receive the portion of the light guided by the light guide unit, and is operable so as to generate an electrical output signal corresponding to the light sensed thereby. The controller is disposed outside the receiving space and connected electrically to the light source unit and the light sensor unit, and controls operation of the light source unit.

### CROSS-REFERENCE TO RELATED APPLICATION

The application claims priority of Taiwanese application No. 094134788, filed on Oct. 5, 2005.

### BACKGROUND OF THE INVENTION

1. Field of the Invention

The invention relates to a backlight module, more particularly to a backlight module which avoids over-saturation of a light sensor unit utilized therein.

2. Description of the Related Art

Referring to FIG. 1, an illumination device disclosed in U.S. Pat. No. 6,448,550 includes a substrate 11, a plurality of light emitting diodes 12 (LEDs) of three colors (i.e., red, green, and blue) mounted on the substrate 11, and a plurality of photodiodes 13 mounted on the substrate 11 and interspersed among the LEDs 12 to collect “averaged” light emitted by the LEDs 12. In the illumination device, the LEDs 12 and the photodiodes 13 are co-mounted on the same substrate 11.

The photodiodes 13 are used for sensing the light emitted by the LEDs 12. Additionally, the illumination device includes a controller (not shown) electrically connected to the substrate 11 for receiving sensor signals from the photodiodes 13, comparing the sensor signals with reference data stored in the controller, and transmitting control signals according to the comparison result to the LEDs so as to adjust the illumination of the LEDs. Therefore, a well-mixed light effect and a desirable illumination can be obtained.

However, since the photodiodes 13 and the LEDs 12 are co-mounted on the same substrate 11, it is difficult to adjust the intensity of the light emitted by the LEDs 12 and received by the photodiodes 13, which results in over-saturation of the photodiodes 13. Therefore, the sensing effect of the photodiodes 13 is adversely affected.

### SUMMARY OF THE INVENTION

Therefore, it is an object of the present invention to provide a backlight module which overcomes the aforesaid disadvantage of the prior art.

In one aspect of the invention, a backlight module includes a base, a light source unit, a light guide unit, a light sensor unit, and a controller. The base confines a receiving space. The light source unit is disposed in the receiving space, and is operable so as to emit light. The light guide unit extends into the receiving space for guiding a portion of the light emitted by the light source unit outwardly from the receiving space. The light sensor unit is disposed outside the receiving space to receive the portion of the light guided by the light guide unit, and is operable so as to generate an electrical output signal corresponding to the light sensed thereby. The controller is disposed outside the receiving space, is connected electrically to the light source unit and the light sensor unit, and controls operation of the light source unit based on the electrical output signal of the light sensor unit.

In another aspect of the invention, a backlight module includes a base, a light source unit, an optical laminate, a light sensor unit, and a controller. The base confines a receiving space and has an open side. The light source unit is disposed in the receiving space, and is operable so as to emit light. The optical laminate is disposed at the open side of the base, and is spaced apart from the light source unit. The light sensor unit is disposed at a periphery of the optical laminate outside the receiving space to receive a portion of the light emitted by the light source unit after the light leaks from the periphery of the optical laminate. The light sensor unit is operable so as to generate an electrical output signal corresponding to the light sensed thereby. The controller is disposed outside the receiving space, is connected electrically to the light source unit and the light sensor unit, and controls operation of the light source unit based on the electrical output signal of the light sensor unit.

### BRIEF DESCRIPTION OF THE DRAWINGS

Other features and advantages of the present invention will become apparent in the following detailed description of the preferred embodiments with reference to the accompanying drawings, of which:

FIG. 1 is a schematic view of a conventional illumination device;

FIG. 2 is a schematic side view of a back light module according to the first preferred embodiment of the invention;

FIG. 3 is a schematic plan view of the backlight module according to the first preferred embodiment of the invention;

FIG. 4 is a schematic diagram of the backlight module according to the first preferred embodiment of the invention;

FIG. 5 is a schematic plan view of the backlight module according to the second preferred embodiment of the invention;

FIG. 6 is a schematic side view of the backlight module according to the third preferred embodiment of the invention;

FIG. 7 is a schematic plan view of the backlight module according to the fourth preferred embodiment of the invention;

FIG. 8 is a schematic plan view of the backlight module according to the fifth preferred embodiment of the invention; and

FIG. 9 is a schematic side view of the backlight module according to the sixth preferred embodiment of the invention.

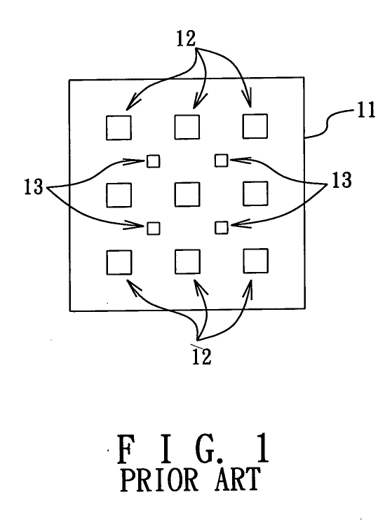

### DETAILED DESCRIPTION OF THE PREFERRED EMBODIMENTS

Before the present invention is described in greater detail, it should be noted that like elements are denoted by the same reference numerals throughout the disclosure.

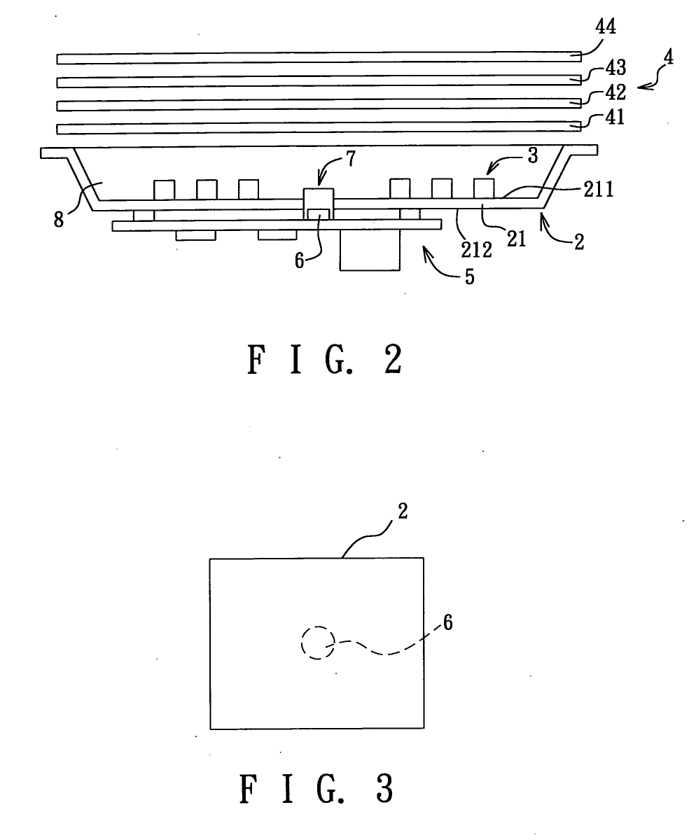

Referring to FIGS. 2 and 3, the first preferred embodiment of a backlight module according to the invention is shown to include a base 2, a light source unit 3, a light guide unit 7, a light sensor unit 6, a controller 5, and an optical laminate 4. The backlight module illustrated in the first preferred embodiment is a direct-type backlight module.

The base 2 confines a receiving space 8, and includes a back plate portion 21 having an inner plate surface 211 and an outer plate surface 212. The light source unit 3 is disposed in the receiving space 8 of the base 2, and is operable so as to emit a light. The light source unit 3 includes a combination of a red light emitting diode, a green light emitting diode, and a blue light emitting diode. Alternatively, the light source unit 3 includes a white light emitting diode. In the preferred embodiment, a combination of red, green and blue light emitting diodes is used as the light source unit 3. Preferably, the red, green and blue light emitting diodes are distributed evenly on the inner plate surface 211 of the back plate portion 21 of the base 2 so as to mix different lights and emit a combined white light.

The light guide unit 7 extends through the inner and outer plate surfaces 211, 212 of the back plate portion 21 of the base 2 and into the receiving space 8 of the base 2 for guiding a portion of the light emitted by the light source unit 3 outwardly from the receiving space 8. The light guide unit 7 is mounted to the light sensor unit 6, and can be made of plastic, polymethyl methacrylate, polycarbonate, glass, or the like. Furthermore, diffusing or filtering elements can be provided on the light guide unit 7 for adjusting the light transmitted through the light guide unit 7.

The light sensor unit 6 is disposed outside the receiving space 8 of the base 2, is disposed to receive the portion of the light guided by the light guide unit 7, and is operable so as to generate an electrical output signal corresponding to the light sensed thereby. The light sensor unit 6 is mounted on one side of the controller 5 that confronts the outer plate surface 212 of the back plate portion 21 of the base 2, and can be a photo-sensor, a photodiode, or the like. Preferably, the light sensor unit 6 is mounted on the controller 5 at a position corresponding to the center of the base 2, as shown in FIG. 3.

The controller 5 is disposed outside the receiving space 8 of the base 2 and adjacent to the outer plate surface 212 of the back plate portion 21 of the base 2, is connected electrically to the light source unit 3 and the light sensor unit 6, and controls operation of the light source unit 3 based on the electrical output signal of the light sensor unit 6. The controller 5 includes a controlling circuit having known functions, such as driving, comparing, storing, adjusting, and the like.

The optical laminate 4 is disposed at an open side of the base 2, and is spaced apart from the light source unit 3. The optical laminate 4 includes a light guide plate 41 proximate to the base 2, a diffuser plate 42 mounted on the light guide plate 41 with a thickness of about 2 mm, a diffuser film 43 mounted on the diffuser plate 42, and a prism sheet 44 mounted on the diffuser film 43. It should be noted that the order and the number of the light guide plate 41, the diffuser plate 42, the diffuser film 43, and the prism sheet 44 can vary according to specific requirements in the practice of the present invention.

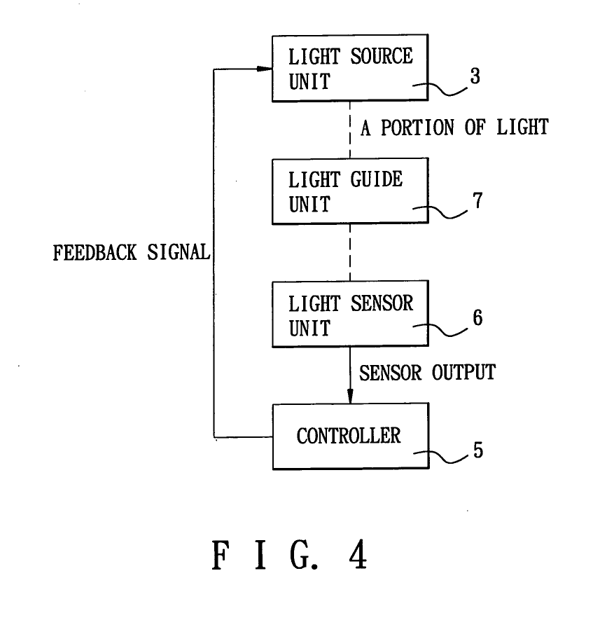

With further reference to FIG. 4, during operation of the backlight module, the red, green, and blue light emitting diodes of the light source unit 3 are actuated to emit red, green, and blue lights, respectively, which are combined to produce a combined white light. A portion of the combined white light is guided by the light guide unit 7 outwardly from the receiving space 8 of the base 2. The light sensor unit 6 receives the portion of the combined white light guided by the light guide unit 7, and operates to generate an electrical output signal corresponding to the light sensed thereby. The electrical output signal is transmitted to the controller 5, and is compared with the reference data stored in the controller 5 so as to output a feedback signal (i.e., a driving current) , which is subsequently transmitted to the light source unit 3 to control operation of the light source unit 3 and adjust the illumination of the light source unit 3 to a desirable level.

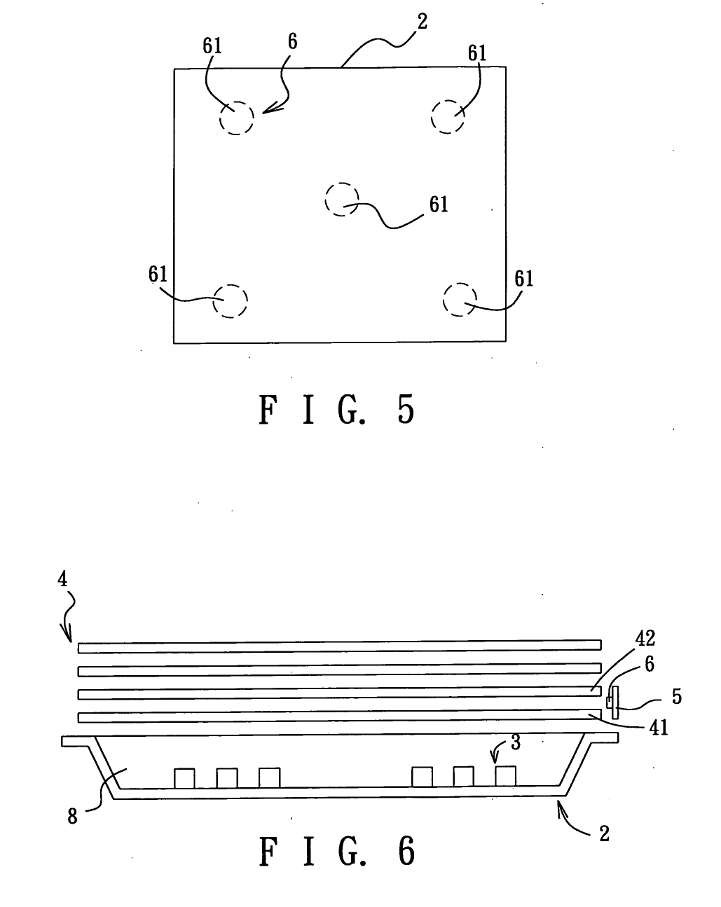

Referring to FIG. 5, the second preferred embodiment of a backlight module according to the invention is shown to be similar to the first preferred embodiment, except that the light sensor unit 6 in the preferred embodiment includes a plurality of sensors 61 to receive the portion of the light guided by the light guide unit 7 in a multi-domain manner.

Referring to FIG. 6, the third preferred embodiment of a backlight module according to the invention is shown to be similar to the first preferred embodiment. The light guide unit 7 used in the first preferred embodiment is not included in the third preferred embodiment. However, in the embodiment, the light sensor unit 6 is disposed at a periphery of the optical laminate 4 outside the receiving space 8 of the base 2 to receive a portion of the light emitted by the light source unit 3 after the light leaks from the periphery of the optical laminate 4, and the light sensor unit 6 is operable so as to generate an electrical output signal corresponding to the light sensed thereby. The controller 5 is mounted laterally and directly to the light sensor unit 6. The portion of the light is emitted by the light source unit 3 to leak from the light guide plate 41 or the diffuser plate 42 of the optical laminate 4 and then received by the light sensor unit 6.

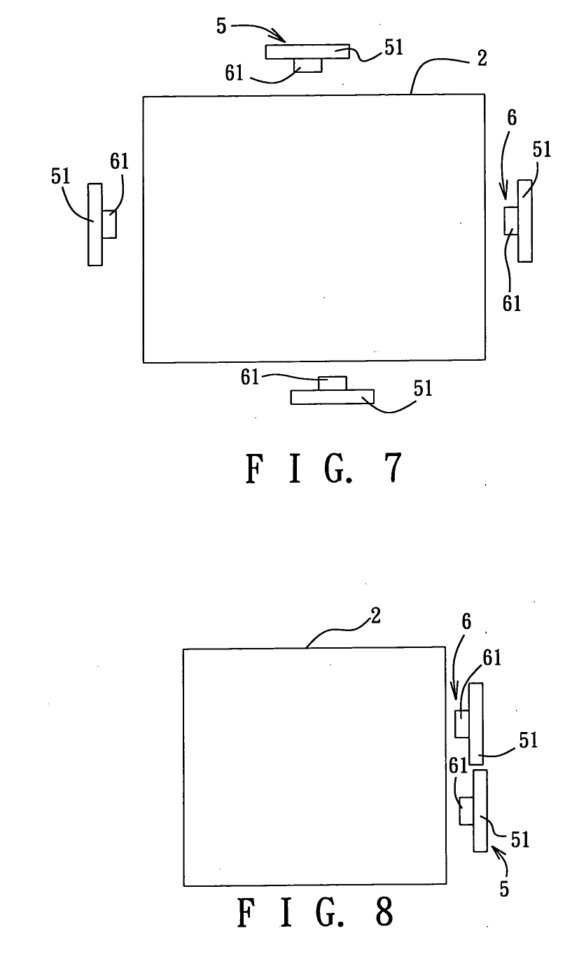

Referring to FIG. 7, the fourth preferred embodiment of a backlight module according to the invention is shown to be similar to the third preferred embodiment, except that the light sensor unit 6 in the preferred embodiment includes a plurality of sensors 61, which are disposed at four sides of the periphery of the optical laminate 4. Furthermore, the controller 5 includes a plurality of controlling units 51 mounted laterally and directly to the sensors 61, respectively.

Referring to FIG. 8, the fifth preferred embodiment of a backlight module according to the invention is shown to be similar to the third preferred embodiment, except that the light sensor unit 6 in the fifth preferred embodiment includes a plurality of sensors 61, which are disposed at one side of the periphery of the optical laminate 4. Furthermore, the controller 5 includes a plurality of controlling units 51 mounted laterally and directly to the sensors 61, respectively.

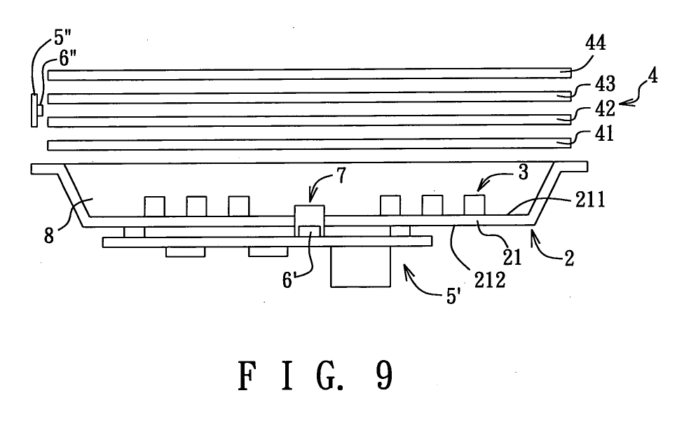

Referring to FIG. 9, the sixth preferred embodiment of a backlight module according to the invention is shown to be similar to the first preferred embodiment. However, the backlight module of the sixth embodiment includes a first light sensor unit 6′, which is identical to the light sensor unit 6 used in the first preferred embodiment, and a second light sensor unit 6″, which is identical to the light sensor unit 6 used in the third preferred embodiment. Furthermore, the backlight module of the sixth preferred embodiment includes a first controller 5′, which is mounted directly below the first light sensor unit 6′, and a second controller 5″, which is mounted laterally and directly to the second light sensor unit 6″.

In view of the aforesaid, since the light sensor unit 6 is disposed outside the receiving space 8 of the base 2, instead of being co-mounted with the light source unit 3 on the back plate portion 21 of the base 2, the over-saturation problem of the light sensor unit encountered in the prior art can be avoided.

While the present invention has been described in connection with what are considered the most practical and preferred embodiments, it is understood that the invention is not limited to the disclosed embodiments but is intended to cover various arrangements included within the spirit and scope of the broadest interpretation so as to encompass all such modifications and equivalent arrangements.

We claim:

1. A backlight module comprising:
a base confining a receiving space;
a light source unit disposed in said receiving space and being operable so as to emit light;
at least one light guide unit extending into said receiving space for guiding a portion of the light emitted by said light source unit outwardly from said receiving space;
at least one first light sensor unit disposed outside said receiving space to receive the portion of the light guided by said light guide unit, and operable so as to generate an electrical output signal corresponding to the light sensed thereby; and
at least one first controller disposed outside said receiving space, connected electrically to said light source unit and said first light sensor unit, and controlling operation of said light source unit based on the electrical output signal of said first light sensor unit.

2. The backlight module as claimed in claim 1, wherein said first light sensor unit is mounted on said first controller.

3. The backlight module as claimed in claim 1, wherein said first light sensor unit includes a photo-sensor and a photodiode alternatively.

4. The backlight module as claimed in claim 1, wherein said light source unit includes a plurality of light emitting diodes.

5. The backlight module as claimed in claim 1, wherein said base includes a back plate portion having an inner plate surface and an outer plate surface, said first controller is disposed adjacent to said outer plate surface of said back plate portion of said base, and said first light sensor unit is mounted on one side of said first controller that confronts said outer plate surface of said back plate portion of said base.

6. The backlight module as claimed in claim 5, wherein said light source unit is mounted on said inner plate surface of said back plate portion of said base.

7. The backlight module as claimed in claim 5, wherein said light guide unit extends through said inner and outer plate surfaces of said back plate portion of said base.

8. The backlight module as claimed in claim 5, wherein said first light sensor unit includes a plurality of sensors mounted spacedly on said first controller.

9. The backlight module as claimed in claim 1, wherein said base has an open side, said back light module further comprising an optical laminate disposed at said open side of said base and spaced apart from said light source unit.

10. The backlight module as claimed in claim 9, wherein said optical laminate comprises a light guide plate and a diffuser plate.

11. The backlight module as claimed in claim 9, further comprising:
at least one second light sensor unit disposed at a periphery of said optical laminate outside said receiving space to receive a portion of the light emitted by said light source unit after the portion of the light leaks from the periphery of said optical laminate, said second light sensor unit being operable so as to generate an electrical output signal corresponding to the light sensed by said second light sensor unit; and
at least one second controller disposed outside said receiving space, and connected electrically to said light source unit and said second light sensor unit for controlling operation of said light source unit based on the electrical output signal of said second light sensor unit.

12. The backlight module as claimed in claim 11, wherein said second light sensor unit is mounted on said second controller.

13. A backlight module comprising:
a base confining a receiving space and having an open side;
a light source unit disposed in said receiving space and operable so as to emit light;
an optical laminate disposed at said open side of said base and spaced apart from said light source unit;
a light sensor unit disposed at a periphery of said optical laminate outside said receiving space to receive a portion of the light emitted by said light source unit after the portion of the light leaks from the periphery of said optical laminate, said light sensor unit being operable so as to generate an electrical output signal corresponding to the light sensed by said light sensor unit; and
a controller disposed outside said receiving space, connected electrically to said light source unit and said light sensor unit, and controlling operation of said light source unit based on the electrical output signal of said light sensor unit.

14. The backlight module as claimed in claim 13, wherein said light sensor unit is mounted directly on said controller.

15. The backlight module as claimed in claim 13, wherein said light sensor unit includes a photo-sensor and a photodiode alternatively.

16. The backlight module as claimed in claim 13, wherein said light source unit includes a plurality of light emitting diodes.

17. The backlight module as claimed in claim 13, wherein said optical laminate includes a light guide plate, the portion of the light being emitted by said light source unit to leak from a periphery of said light guide plate of said optical laminate and then received by said light sensor unit.

18. The backlight module as claimed in claim 13, wherein said optical laminate includes a diffuser plate, the portion of the light being emitted by said light source unit to leak from a periphery of said diffuser plate of said optical laminate and then received by said light sensor unit.

19. The backlight module as claimed in claim 13, wherein said light sensor unit includes a plurality of sensors disposed at at least two opposite sides of the periphery of said optical laminate, and said controller includes a plurality of controlling units mounted directly to said sensors, respectively.
